(19) United States
(12) Patent Application Publication
(10) Pub. No.: US 2006/0122896 A1
(43) Pub. Date: Jun. 8, 2006

(54) Green touch display advertising kiosk system

(76) Inventor: Andrew J. Parsley, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/007,040

(22) Filed: Dec. 8, 2004

(51) Int. Cl. G06Q 30/00

(52) U.S. Cl. 705/26

(57) ABSTRACT

An advertising system that provide ordering and payment of services, food or goods. The advertising system provides continuous advertising at a kiosk terminal that can be located at a restaurant, medical, dental, car wash, or other establishment. The system provides for multiple methods of payment for services. The system can be used for game playing, food ordering, Internet access, news or email. Other functions include camera, voice, and other forms of data exchange with the system. The system also allows for a portable kiosk that provides all the functions of a fixed kiosk with the addition of a paging feature to notify the user when their table is ready, and a tracking feature in the event of theft.

### FIELD OF THE INVENTION

This invention relates to new and useful advertising system that operates where people are waiting. More particularly this advertising system is for use in restaurants, airports, service stations, hotels, or medical offices such as doctor or dentist offices. The advertising system provides ordering of food or services, game playing, Internet access in addition to advertising that continues to be displayed. The advertising system may also allow customers to order food at the table in addition to paying the bill or requesting a drink be filled. The advertising system may also include a portable kiosk that provides paging of patrons in addition to the other feature previously listed. The advertising can consist of one or multiple ads running at the same time. The ads can also be changed based upon the action of the user.

### BACKGROUND OF THE INVENTION

The prior art discloses many examples of apparatus for advertising and E-Commerce but none providing the combination of features disclosed and claimed herein.

U.S. Pat. No. 5,484,638 issued to Crabtree on Jan. 16, 1996, U.S. Pat. No. 6,123,031 issued to Hayman-Chaffey Sep. 26, 2000 and U.S. Pat. No. 6,739,271 issued to Hancock on May 25, 2004 disclose a variety of advertising methods where advertising is placed on or within a table at a restaurant. While these patents provide advertising they only provide fixed advertising that requires a person to change the advertising. The advertising also does not allow the user to payment options at the table or interaction with the advertising.

U.S. Pat. No. 4,306,388 issued to Yuter on Dec. 22, 1981 discloses a restaurant entertainment system. This system provides entertainment and order taking/order filling system. This system allows people to place order that are then communicated to other parts of the restaurant for filling. The system is intended to improve the efficiency of the restaurant. While this system provides order taking, the system does not provide advertising or user interactive E-business.

U.S. Pat. No. 6,484,148 issued to Boyd on Nov. 19, 2002 discloses an advertising system that focuses advertising to people based upon identifiers such as prior buying habits. The advertising requires prior information regarding the user and products or services they previously purchased. While this system allows more focused advertising, this method does not allow the user to purchase products, nor is the system intended for use in a restaurant or similar location people are waiting for service.

U.S. Pat. No. 6,609,102 issued to Kolls and U.S. Pat. No. 6,629,080 issued to Kolls and numerous other similar US patents issued to Kolls, and assigned to USA Technologies Inc. disclose an advertising and payment system for E-commerce and service. These patents are all intended for un-attended systems where a person interacts with the kiosk, vending machine, and stand alone or networked terminal to transact E-business or purchase a vended product. While these patents provide a method for E-business purchasing transactions, they do not provide for E-business where human services are available such as restaurants, medical services, bars, or hotels.

What is needed is an electronic advertising device that can be used in a restaurant, medical service location, or similar location. The ideal device would allow a person to order and pay for services at the device. The device would also provide advertising of products or service for the establishment or local establishments. The devise would also allow Internet access, game playing, news and other service in addition to the other feature previously identified.

### BRIEF SUMMARY OF THE INVENTION

One of the objects of this invention is to provide an E-business system for use in locations where human services are available. A main advantage of the system is to provide advertising and entertainment when a person is waiting for food or services. This waiting time allows a person to can catch-up with business when they can use the time more efficiently.

The system provides multiple methods for a person to pay for the services. These methods include a card swipe for credit, debit cards, E-money, thumbprint, retinal, or other methods to provide a unique identifier for each user to transact or pay of service. The user also has the option to pay for the service by cash.

Another advantage of the system beyond entertaining customers is that the system can provide additional income to the establishment. The additional income is based upon payment for the playing and Internet use of the system.

Another feature of the system is to provide one or more running ads that the patron can select to receive additional information.

Another feature of the system is to allow the person to order a complete meal from the terminal. The ordering process can allow the user to see the item being ordered and to see the changes to the item being ordered if they want to customize a standard item on the menu. The system can also advise or suggest items from the menu.

Another feature of the system could capture, send or provide pictures, video and sound. This would allow a family to send an electronic postcard or email to friends or family while they are on vacation.

Another feature of the system would allow game playing or Internet services. They can also receive directions or information on points of interest near their current location. They can also find or arrange for future reservations, lodging or dining.

Interaction with the system can provide points or discounts on food or services based upon usage on the system.

Another advantage of the system can be at a gaming establishment where a person can continue to gamble while they wait for food to be brought to them.

Another advantage of the system would be to provide the system as a portable unit that allows waiting customers to pre-order food prior to being seated. This portable system would also provide the advertising, gaming, Internet and E-services of a table-mounted unit.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view of the kiosk on a table.

FIG. 2 is a top view of one possible configuration of the kiosk showing the display and connections to the kiosk

FIG. 3 is a block diagram of the kiosk showing the functions and how they connect to the kiosk.

FIG. 4 is a flow diagram describing how a user might use the kiosk.

### DETAILED DESCRIPTION OF THE INVENTION

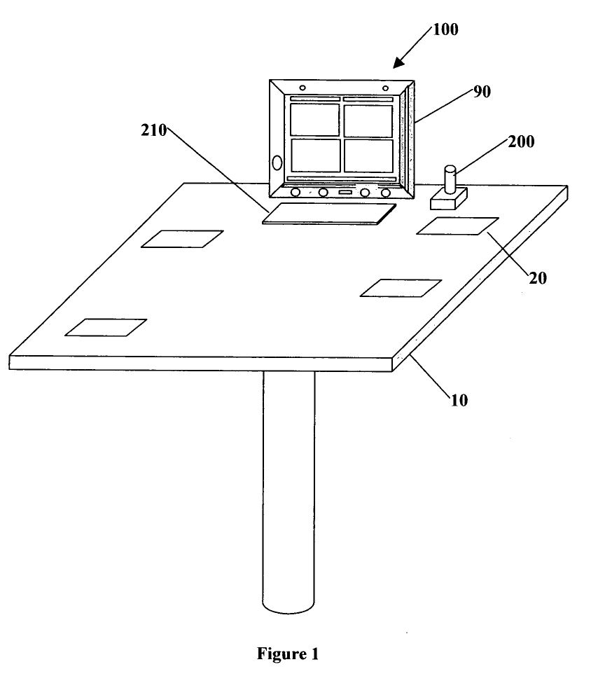

Referring to FIG. 1, there is shown isometric view of the kiosk on a table. From this figure the kiosk 100 is shown on the back edge of the table 10. The table is shown set with four place settings 20, but the kiosk may be placed in a number of locations where human services are available. A hand controller 200 is shown on the table in addition to a keyboard 210. The hand controller and keyboard are some forms of entering data, information or input into the kiosk. The kiosk may alternately be configures with a touch screen or other forms of input devices. The enclosure 90 of the kiosk is shown as a rectangular tablet, but the shape of the kiosk can be any shape that provides some or all the functions herein described.

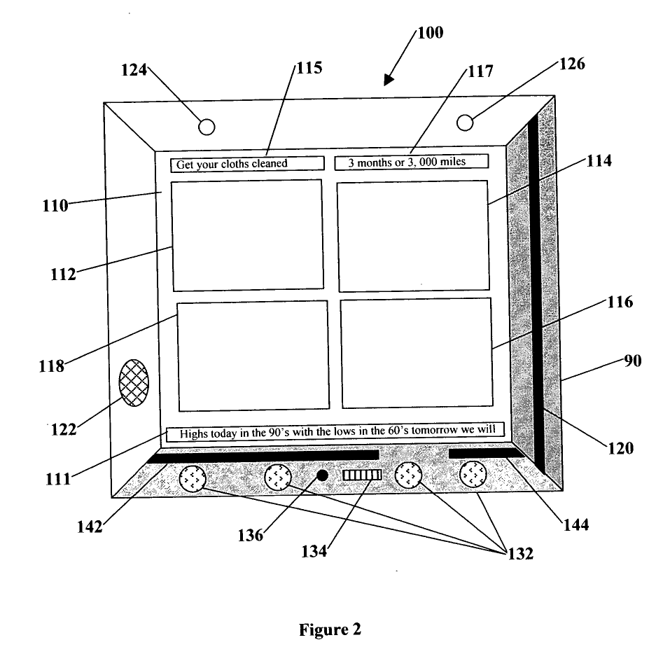

Refer now to FIG. 2 that shows a top view of one possible configuration of the kiosk 100 showing the display and connections to the kiosk. The kiosk 100 has a display area 110. In the preferred embodiment the display is a LCD display with touch screen capabilities. The screen can display one image, movie, and set of text or picture. In the preferred embodiment the display show four sets of advertising 112, 114, 116, 118. These four or more areas of advertising can include information regarding goods or services available at the establishment, or may contain advertising for goods or service that are available outside the establishment. In addition or instead of the advertising, the advertising may be in the form of crawling information that takes place at some other place on the screen. In this figure the crawling advertising is shown at the bottom 111 and top 115, 117 of the display. Various types of information can be displayed that will provide interest or advertising to a customer. The advertising may also include audio or sound from a speaker or transducer. If a user selects various functions from the kiosk, the display will change to support the other function, but will continue to provide some form of advertising.

The kiosk can be provided and used in a variety of locations where human service are available, some examples of these locations include but are not limited to restaurants taxi, bus, boat, air, airports, rail services, doctors offices, dentist offices, hotels, auto service, tax services, legal offices.

If the Kiosk is provided in a restaurant, the kiosk may show food specials that are available at the restaurant. A customer may select food service from a menu of options read about the food choices and order food from the menu. As the order is being entered or selected the customer may be able to visually see a number of pieces of information in the screen. The information available may include one or more of the following pieces of information including but not limited to the order as it is being entered, the total order, the cost so far entered with suggested tip, estimated time to delivery at the table, customization of the order as it is being placed. An example of customization may include showing an image of the food that is being ordered, and options, toppings, substitutions, cooking levels, and condiments. The kiosk may also guide customers in selection of what to order based upon a set of questions or suggestions. The kiosk may also help sell items that are higher profit level to increase revenue to the establishment. A customer can also notify the host how many waters are needed at the table or when the table is ready for re-fills, coffee or clearing of the table.

In addition to advertising, the kiosk offers may options for use by customers for a fee. These options may include but are not limited to directions to places of interest or services available nearby, game playing, movie watching, internet access, email, research or other services that are available from a computer, internet or game playing machine. The kiosk may have one or more connections for game controller 132 or connection for a user provided memory or flash card that can be inserted into a memory or card reader slot 134 that can be read by the kiosk. In one embodiment the memory card may contain digital picture that a customer can load into the kiosk and then email to a third party. One or more connections 136 for headphones can be connected to the kiosk to allow a person to listen to the kiosk without the sound being heard by other people or disturbing other people.

These additional services can be selected from the kiosk and paid by swiping a credit card, debit card, user account, prepaid service or inserting money into the kiosk. The kiosk may include a scanner, card or magnetic strip reader 120, fingerprint scanner 122, retinal scanner 124, voice recognition device or other from of identifying a unique user to the kiosk. The kiosk may also include a camera 126 that can take pictures, movies of customer and then sends them to a third party.

The kiosk may also include output devices beyond the display and speaker(s). The output devices may include but not be limited to printers 142, cash or money dispensers 144. The printers can print a variety of items including pictures, email, tickets, credit card receipts or coupons. The money or cash dispenser allows users to get cash for future use. The user can use the kiosk for payment of goods or services from the establishment as well as use of the kiosk.

Use of the kiosk may allow the user to receive discounted or free meals or deserts from the establishment. The user may receive credits for future use of the kiosk or establishment.

The kiosk shown in FIGS. 1 and 2 show the kiosk located on a table, but some or the entire kiosk can be portable or movable. In one embodiment the kiosk is tethered to each table. This allows the kiosk to be moved to any point around the table. An example of this use for the kiosk would allow a child at the table to play a game or watch a movie while the adults talk prior to the arrival of food. In another contemplated use for the tethered kiosk allows one person to transact private communication with a home office without the remainder of the table seeing the exchange of information. In a portable embodiment the kiosk can be lifted from a charging cradle. In this embodiment it is contemplated that when a customer arrives at a restaurant and has to wait, the customer can take a kiosk after scanning a credit card or other form of identification securing that provides collateral for the kiosk. The customer can track the wait time while they perform work on the kiosk or are entertained. The portable kiosk can notify the user much like a pager when their table is ready. While they have the portable kiosk they can also review the menu and order food that can be delivered at the table within minutes of being seated. A customer can place a call with the kiosk or exchange email as they wait.

In the portable kiosk embodiment, the kiosk may include a GPS transponder to guard against the kiosk being taken or stolen. The establishment may be able to track the location of each kiosk, and if the kiosk is taken beyond a defined distance or communication with the kiosk is lost or missing for too long, then further action can be taken.

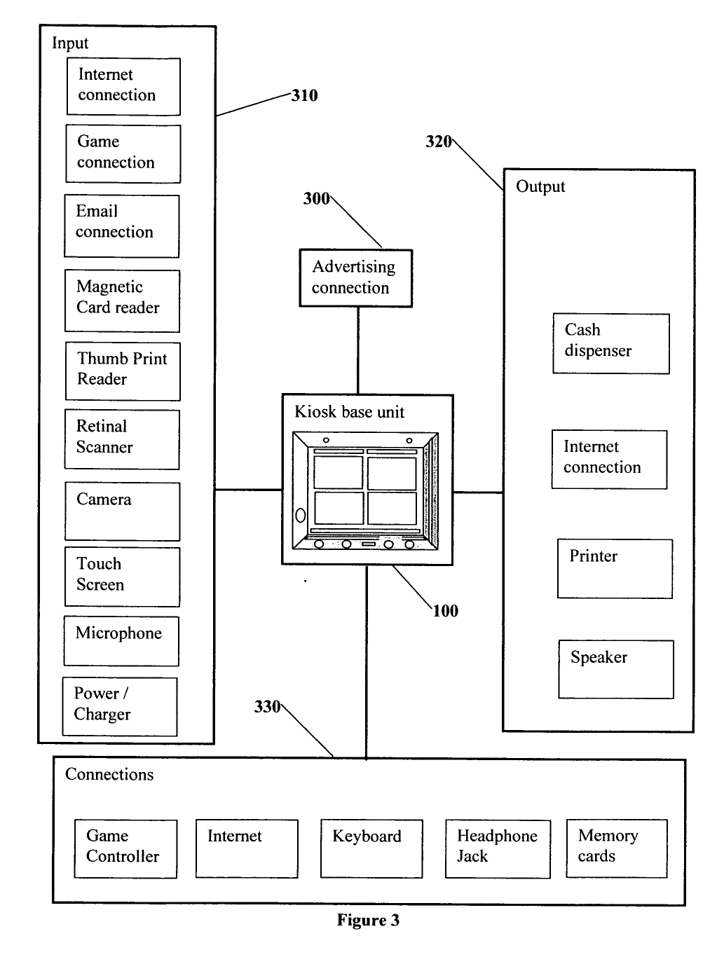

Refer now to FIG. 3 that show a block diagram of the kiosk showing the functions and how they connect to the kiosk. The kiosk base unit 100 is shown in the center of this figure with the Input 310, Output 320, and connections 330 and the advertising connection 300. While these functions, connections or devices are shown external to the kiosk base unit, these functions are integrated into the kiosk, but some or all can be external to the kiosk depending upon the configuration of the kiosk as manufactured or configured. The advertising connection 300 is shown as a single connection to the kiosk, because the advertising is one of the prime functions of the kiosk. The advertising can be loaded or re-loaded into the kiosk so it can operate as a stand-alone advertising unit without requiring any other connection except for power from an internal or external source.

The Input function consists or numerous types of connections or devices that can connect or provide additional user options that enhance or encourage use of the kiosk. These function include but are not limited to Internet connection, game connection, email connection, magnetic car reader, thumb print reader, image or money scanner, retinal scanner, camera, touch screen, microphone and power or charger. The input also allows a customer to listen to the radio, music, watch TV, sporting events, the stock market, advertisement or other visual or audio-visual information

The Internet connection allows the customer all the functions that are available on the Internet. The Internet allows a wide variety of functions that may overlap other functions of the kiosk. The Internet connection allows a customer to email, research, get information, play games, get and or send messages. The Internet access can also allow a customer to access file for a computer located at a location that is distal from the kiosk. The game connection can allow game playing from a variety of sources including game cartridges, CD games connected to the kiosk or accessed by the kiosk. Some games may also be installed in the kiosk that allows customers to play the kiosk when it is not connected to a network or the Internet. The game playing may also include casino game or games of chance that can be played for amusement or for money.

The input functions can also include at least one magnetic card reader. The card reader can be a variety of types that allow the kiosk to identify the user and bill to a specific account or person. Other forms of user identification available on the kiosk may include but not be limited to thumb print scanner, voice recognition, retinal scanner or other forms of user identifying methods. The retinal scanner can be a separate device, or can be a function of the camera. While the camera can perform the function of performing a retinal scan, the camera can provide still or moving pictures or images. In one contemplated example, a customer can celebrate a birthday party, and can use the kiosk to send live video with or without audio to family or friends that cannot attend the celebration. The screen may include a touch screen or a series of buttons located about the edges of the screen to select items. The touch screen allows the customer to select items, play games and write on the screen using a finger pen or stylus. Another function can include the use of a microphone. The microphone can perform a number of functions including but not limited to voice recognition, recording messages, responding to messages, phone service, and sending audio files. The kiosk can allow communication between other tables at the establishment. This will allow one person at one kiosk to communicate with another person at another kiosk within or outside the establishment.

The kiosk can include memory that remembers customer preferences. This memory allow the kiosk to recall TV stations, radio stations, sports selection, stock information and other uses of the kiosk that allows the kiosk to appear personalized for future use.

The kiosk can include a number of connections that allow the kiosk to operate with a number of devices including but not limited to game controller or various type, Internet connection, mice, trackballs, keypads, keyboard, memory cards, CD, DVD, floppy and or other removable drives. These entire connection devices use protocols communication and connections that are best described by the manufacturers. The kiosk merely provides a connection point for these devices to connection to the kiosk for use with the kiosk. It is also contemplated that a connector can be included for a money scanner or receiver that allows a person to pay with cash. After using the kiosk the customer can select to pay for the meal and or kiosk service at the cash register.

The kiosk can provide a number of output functions beyond what is displayed on the display. The output functions include but are not limited to Internet connection, cash dispenser, printer and speaker. The Internet connection allows access to Internet function that would be available on a PC with an Internet connection. The kiosk can sent a receipt or information to another location, another kiosk, email, or to the cash register of the establishment to be print for payment. The cash dispenser allows customer access to an ATM at the kiosk. The functions of the cash dispenser and operation of the cash dispenser is similar to an ATM machine with the ability to access money, accounts and cash. The kiosk may also includes a printer that can be used to print coupons, receipts, pictures or any other type of printed material including emails that are received from the internet. A speaker may also be included that allows customers to listen to information, music or talk with other people like a telephone or picture phone.

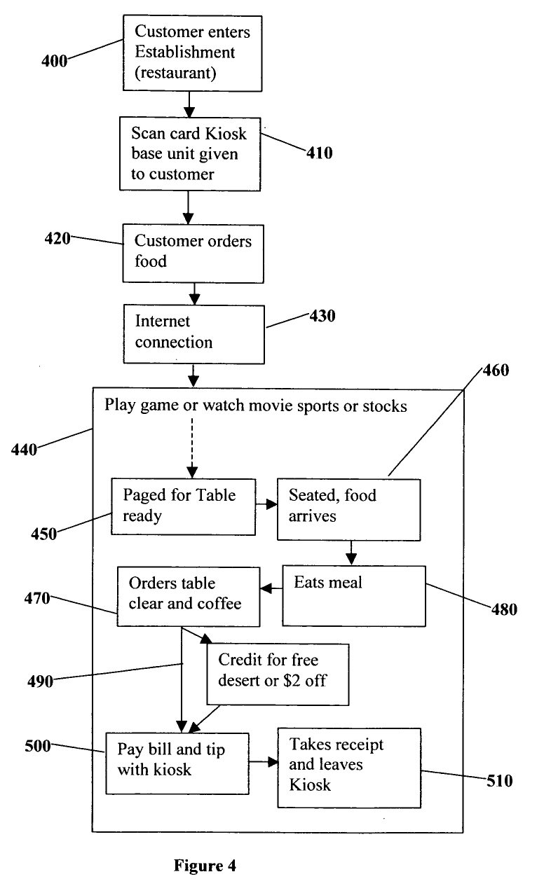

FIG. 4 is a flow diagram describing how a user might use the kiosk. A customer enters an establishment, in the case of this example; the establishment is a restaurant 400. The restaurant is supports the kiosk system as described in this patent. The kiosk scrolls a continuous stream of advertisement as either crawling ads placed on the top or bottom of the screen, or as images that placed on the screen. If the customer sees advertisement they want more information on, they can select the advertisement and get additional information. When the customer enters the restaurant they find that there is a wait of 30 to 45 minutes for a table. The customer is issued a kiosk, and scans their credit card 410 or other forma of collateral to use the kiosk. The customer sits in a waiting area or bar, and looks over the menu. They select the meal 420, and select the dressing for their salad, topping for a baked potato, and how they want their steak cooked. They then check the time wait time. They find the wait time is now 15 minutes. They log onto the Internet 430 and checked and respond to emails. The kiosk then pages 450 the customer to notify them that a table is ready, so the customer takes the kiosk to the table. In box 440 the customer is seated at a table and interacts with the kiosk during the meal. The customer is seated at the table 460, and the salad or other food is delivered. The customer eats 480 the meal as they listen to the radio, music, watch TV, sporting events, the stock market, advertisement or other visual or audio-visual information. As they finish the meal, they select to have the table cleared and have coffee delivered to the table 470. When the select payment option on the kiosk, the kiosk gives them a discount or offers a free desert 490. The customer takes the discount, and the kiosk accepts payment for use of the kiosk and the meal 500. The kiosk also provides information on tipping. The kiosk prints a receipt 510, and the customer takes a receipt printed by the kiosk, and leaves the kiosk at the establishment when they leave.

Thus, specific embodiments applications and functions for an advertising kiosk have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A Kiosk advertising and ordering system comprising:
a stand alone or networked kiosk for use where human services are available wherein the human services include food service, transportation service, and professional service, and
the kiosk receives input including tactile, audible response from at least one user, and
the kiosk displays at least one form of electronic changeable advertising that may or may not be associated with the human services available where the kiosk is located, and
the kiosk can provide services including food ordering, entertainment, Internet access, communication, and payment options for consumable and services.

2. The kiosk from claim 1 wherein use of the kiosk for purposes other than advertising requires payment for use.

3. The kiosk from claim 1 wherein the kiosk can be portable by removing the kiosk from a charger or from a tethered base location.

4. The kiosk from claim 3 wherein the kiosk includes an alarm or notification function if the kiosk is stolen, tampered, moved a defined distance or does not communicate with a period of time

5. The kiosk from claim 1 wherein the kiosk is not hardwired for communication with a network.

6. The kiosk from claim 1 wherein the kiosk includes capability for still picture, moving picture, video and audio that can be set from the kiosk to another location or stored for future reference.

7. The food ordering services from claim 1 wherein the food service include ordering from a menu where the food is served manually, information regarding wait time(s), refills, status of food preparation.

8. The food service ordering from claim 7 wherein as the food is ordered the display of the kiosk is updated to show the order and any customization of menu items in words, text or images.

9. The transportation services from claim 1 wherein the transportation service includes taxi, bus, boat, air, airports, rail services or something other than taxi, bus, boat, and rail services.

10. The professional service from claim 1 wherein the professional service includes restaurants, doctors, dentist, hotels, auto service, tax services, legal services or something other than restaurants, doctors, dentist, hotels, auto service, tax services and legal services.

11. The tactile input from claim 1 wherein the tactile input includes touch screen, stylus, keyboard, mouse, trackball, graphical input device, hand controller, game controller, scanner, finger print recognition or something other than touch screen, stylus, keyboard, mouse, trackball, graphical input device, hand controller, game controller, scanner, finger print recognition.

12. The audible response from claim 1 wherein the audible response includes voice recognition, operation from voice commands, and optionally voice reply from the kiosk, playing of news, music, radio, TV, phone calls or other audible feedback.

13. The changeable advertising from claim 1 wherein the advertising wherein the changeable electronic advertising includes at least one repeatable visual and or audible ad that advertises information regarding the establishment, local or distal establishments.

14. The kiosk from claim 1 wherein the kiosk allows at least one of the following capabilities including but not limited to on or offline game playing, internet access, banking and ATM.

15. The kiosk from claim 1 wherein the kiosk can read and bill to a users credit card, drivers license, user id, or account.

16. The kiosk from claim 1 that further includes a global positioning system, or other location tracking mechanism.

17. The kiosk from claim 1 further includes a dispensing or printing mechanism for currency, coupons, ticket, vouchers, or other monetary items.

18. The kiosk from claim 1 further includes a receiving mechanism for currency, coupons, ticket, vouchers, or other monetary items.

19. The kiosk from claim 1 further includes at least one memory storage including RAM, ROM, HDD, Flash, bubble, Floppy drive, memory card and CD-ROM.

20. The kiosk from claim 1 further provides income for and or from advertising that is displayed.
